(19) United States
(12) Patent Application Publication
(10) Pub. No.: US 2025/0016079 A1
(43) Pub. Date: Jan. 9, 2025

(54) ANALYSIS DEVICE, ANALYSIS METHOD, AND ANALYSIS PROGRAM

(71) Applicant: Nippon Telegraph and Telephone Corporation, Tokyo (JP)

(72) Inventors: Shohei KAMAMURA, Musashino-shi, Tokyo (JP); Yuhei HAYASHI, Musashino-shi, Tokyo (JP); Masato YAMADA, Musashino-shi, Tokyo (JP); Chiharu MORIOKA, Musashino-shi, Tokyo (JP); Satomi Inoue, Musashino-shi, Tokyo (JP); Yuki MIYOSHI, Musashino-shi, Tokyo (JP); Akinori FURUTA, Musashino-shi, Tokyo (JP)

(21) Appl. No.: 18/704,510

(22) PCT Filed: Nov. 8, 2021
(86) PCT No.: PCT/JP2021/041038

§ 371 Date: Apr. 25, 2024

(51) Int. Cl. H04L 43/08; H04L 41/147

(52) U.S. Cl. CPC H04L 43/08; H04L 41/147

(57) ABSTRACT

A division unit divides communication traffic in a communication network into a plurality of streams. A calculation unit calculates a first abnormality degree based on a result of autoregressive analysis of a first stream among the plurality of streams, and a second abnormality degree based on a comparison result between the first stream and a second stream similar to the first stream. A determination unit determines whether the cause of the abnormality is the first stream, a stream different from the first stream, or a communication network based on the first abnormality degree and the second abnormality degree.

### TECHNICAL FIELD

The present invention relates to an analysis device, an analysis method, and an analysis program.

### BACKGROUND ART

In a carrier network that supports social infrastructure, such as video distribution, web conference connection in the new normal, and Cloud interconnect for DX promotion, it is required to quickly detect and respond to abnormality of a communication network.

A service using a carrier network includes complex and various components such as a mobile base station, a relay core network, and an OTT cloud. In a carrier network that provides a relay network, it is required not only to quickly detect abnormality and failure of the own network, but also to quickly detect abnormality at the service end end including abnormality on the access side or the OTT side to realize stable use of the social infrastructure.

Conventionally, as a technique for detecting and predicting an abnormality of a communication network from traffic, for example, a stream mining technique for discovering various features from time-series data such as communication traffic has been established (for example, refer to Non Patent Literature 1).

In addition, a method of classifying traffic based on a certain rule and analyzing the classified traffic by future prediction or the like has been proposed (for example, refer to Non Patent Literature 2).

### CITATION LIST

### Non Patent Literature

Non Patent Literature 1: Machiko Toyoda, Yasushi Sakurai, Yoshiharu Ishikawa, “Pattern discovery in data streams under the time warping distance,” VLDB Journal, pp. 295-318, 2013.
Non Patent Literature 2: Komai, Kimura, Kobayashi, Harada, “a traffic prediction method based on an access pattern for realizing a proactive control type network,” The Institute of Electronics, Information and Communication Engineers General Meeting B-7-50, 2019.3

### SUMMARY OF INVENTION

### Technical Problem

However, the conventional technique has a problem that it is difficult to accurately perform traffic analysis of a carrier network.

For example, since the large-capacity traffic flowing through the carrier network is obtained by superimposing a plurality of flows, it is difficult to ascertain a change in the feature amount in the stream mining described in Non Patent Literature 1.

In addition, for example, since the classification method described in Non Patent Literature 2 performs prediction classification based on a tendency instead of a definite classification, there is a case where classification cannot be performed with high accuracy.

### Solution to Problem

In order to solve the above problems and achieve the object, there is provided an analysis device including: a division unit that divides communication traffic in a network into a plurality of streams; and a calculation unit that calculates an abnormality degree of the first stream based on a result of autoregressive analysis of a first stream among the plurality of streams, and a comparison result between the first stream and a second stream similar to the first stream.

### Advantageous Effects of Invention

According to the present invention, it is possible to accurately perform traffic analysis of a carrier network.

### BRIEF DESCRIPTION OF DRAWINGS

FIG. 1 is a diagram illustrating a configuration example of a carrier network.

FIG. 2 is a diagram illustrating a configuration example of an analysis system according to a first embodiment.

FIG. 3 is a diagram illustrating a configuration example of an analysis device according to the first embodiment.

FIG. 4 is a diagram for explaining a flow of analysis processing.

FIG. 5 is a diagram for explaining each stream.

FIG. 6 is a diagram illustrating an example of codes of a program for executing analysis.

FIG. 7 is a diagram for explaining a stream from a service side.

FIG. 8 is a diagram for explaining a method of determining a type of an alert related to the stream from the service side.

FIG. 9 is a diagram for explaining a stream from an access side.

FIG. 10 is a diagram illustrating a method of determining a type of an alert related to the stream from the access side.

FIG. 11 is a diagram for explaining a method for learning a threshold.

FIG. 12 is a diagram for explaining focused monitoring of a specific user.

FIG. 13 is a flowchart illustrating a flow of processing of the analysis device according to the first embodiment.

FIG. 14 illustrates an example of a computer that executes an analysis program.

### DESCRIPTION OF EMBODIMENTS

Hereinafter, embodiments of an analysis device, an analysis method, and an analysis program according to the present application will be described in detail with reference to the drawings. Note that the present invention is not limited to the embodiment described below.

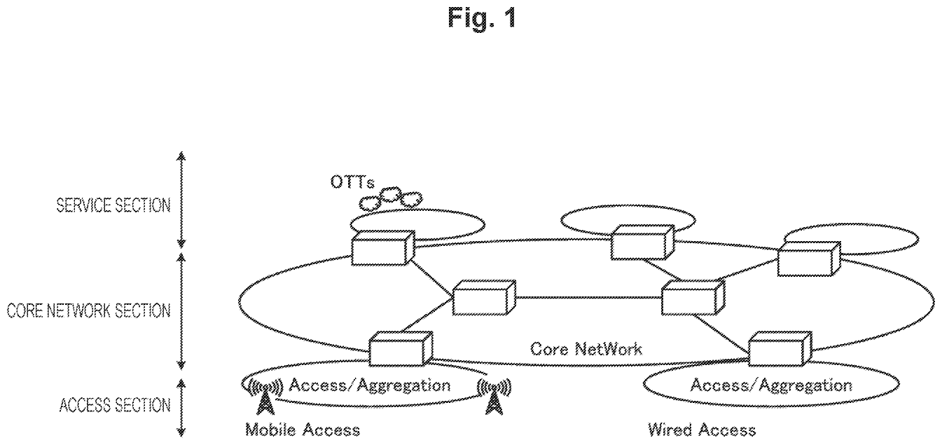

First, a carrier network which is an analysis target in the embodiment will be described with reference to FIG. 1. FIG. 1 is a diagram illustrating a configuration example of the carrier network.

As illustrated in FIG. 1, the carrier network includes a service section, a core network section, and an access section.

Over The Top (OTT) exists in the service section. In the access section, there are a base station and a user accommodated in the base station.

In the following description, a service section viewed from a core network may be referred to as a service side. In addition, an access section viewed from the core network may be referred to as a service side.

One object of the present embodiment is to analyze traffic accurately in a large-scale carrier network as illustrated in FIG. 1, and as a result, promptly detect an abnormality in a service end end including an abnormality on an access side or a service side (OTT side), thereby realizing stable use of a social infrastructure.

Here, in stream mining as described in Non Patent Literature 1, time-series data that occurs from moment to moment is defined as a stream, and features of the stream itself are found (trend detection and statistical information acquisition), the future is predicted (predicted), and streams and sequences are compared (similarity search and clustering).

On the other hand, when the large-volume traffic flowing through the carrier network is regarded as a stream, a plurality of flows are superimposed on the stream. Therefore, in the conventional stream mining, it is difficult to grasp a change in the feature amount of the large-volume traffic flowing through the carrier network.

For example, in a carrier network, even when a specific service fluctuates due to a service abnormality, hardly any change appears in the overall traffic due to a large group effect.

Furthermore, the classification method as described in Non Patent Literature 2 performs classification only based on the behavior of traffic, and cannot necessarily perform classification with high accuracy.

For example, even when the traffic of the carrier network is classified into a traffic pattern having a specific fluctuation by the technique of Non Patent Literature 2, a plurality of different services may be superimposed on the classified traffic pattern, and it is difficult to grasp the fluctuation limited to the specific service using the classification result.

### Configuration of First Embodiment

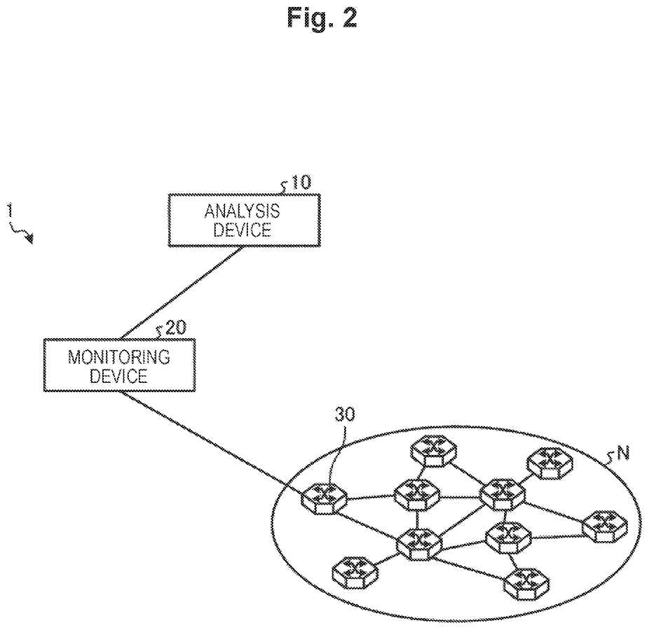

FIG. 2 is a diagram illustrating a configuration example of an analysis system according to a first embodiment. As illustrated in FIG. 2, the analysis system 1 includes an analysis device 10 and a monitoring device 20.

The analysis device 10 and the monitoring device 20 can communicate data with each other. The analysis device 10 and the monitoring device 20 are, for example, servers.

The monitoring device 20 is connected to a communication network N. For example, the communication network N is the core network in FIG. 1.

For example, the monitoring device 20 is connected to a node 30 included in the communication network N. The node 30 is, for example, a server, network equipment, or the like.

The monitoring device 20 acquires information on the communication network N from the node 30, and transmits the acquired information to the analysis device 10.

For example, the monitoring device 20 acquires network configuration information (connection information of nodes and links) of the communication network N, traffic information (flow information, packet capture), and route information through which traffic flows.

The analysis device 10 performs traffic analysis related to the communication network N based on the information provided from the monitoring device 20. The analysis device 10 can output an analysis result to a user or another device (GUI device and terminal device) via the user interface.

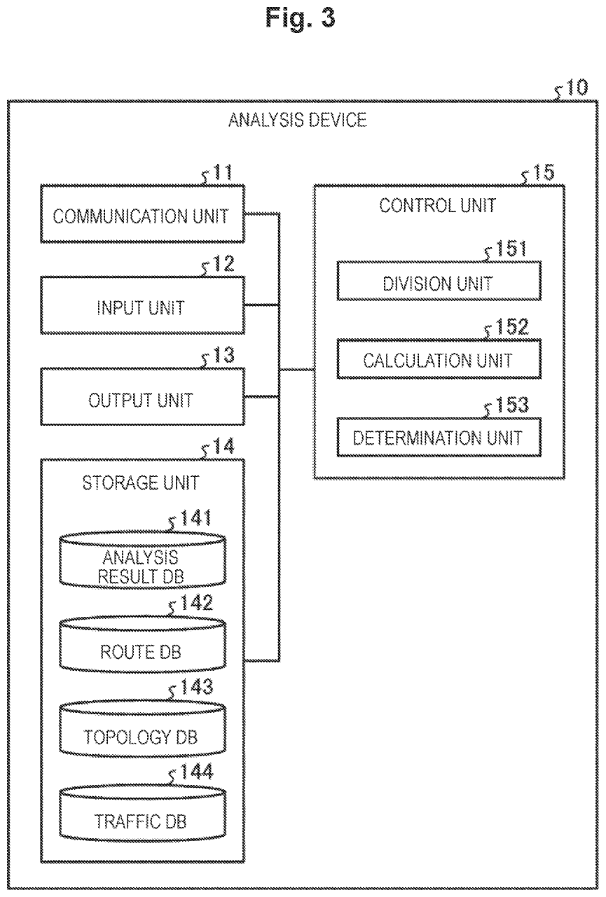

A configuration of the analysis device 10 will be described with reference to FIG. 3. FIG. 3 is a diagram illustrating a configuration example of the analysis device according to the first embodiment.

As illustrated in FIG. 3, the analysis device 10 includes a communication unit 11, an input unit 12, an output unit 13, a storage unit 14, and a control unit 15.

The communication unit 11 performs data communication with other devices via a network. For example, the communication unit 11 is a network interface card (NIC). For example, the communication unit 11 performs data communication with the monitoring device 20.

The input unit 12 receives an input of data from a user. The input unit 12 is, for example, an input device such as a mouse or a keyboard.

The output unit 13 outputs data by displaying a screen or the like. The output unit 13 is, for example, a display device such as a display.

The storage unit 14 is a storage device such as a hard disk drive (HDD), a solid state drive (SSD), or an optical disc. Note that the storage unit 14 may be a semiconductor memory capable of rewriting data, such as a random access memory (RAM), a flash memory, or a non volatile static random access memory (NVSRAM).

The storage unit 14 stores an operating system (OS) and various programs executed by the analysis device 10.

The storage unit 14 stores an analysis result DB 141, a route DB 142, a topology DB 143, and a traffic DB 144.

The analysis result DB 141 stores a result of traffic analysis. The traffic analysis is performed by each unit of the control unit 15 described later.

The result of the traffic analysis stored in the analysis result DB 141 is output via the communication unit 11 or the output unit 13.

The route DB 142 stores route information through which communication traffic flows in the communication network N.

The topology DB 143 stores connection information between nodes and links of the communication network N.

Traffic information (for example, flow information) is stored in the traffic DB 144.

The information of the route DB 142, the topology DB 143, and the traffic DB 144 may be stored via the monitoring device 20 or input by an operator.

The control unit 15 controls the entire analysis device 10. The control unit 15 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

Further, the control unit 15 includes an internal memory for storing programs and control data defining various processing procedures, and executes each type of processing using the internal memory.

Furthermore, the control unit 15 functions as various processing units by operating various programs.

For example, the control unit 15 includes a division unit 151, a calculation unit 152, and a determination unit 153.

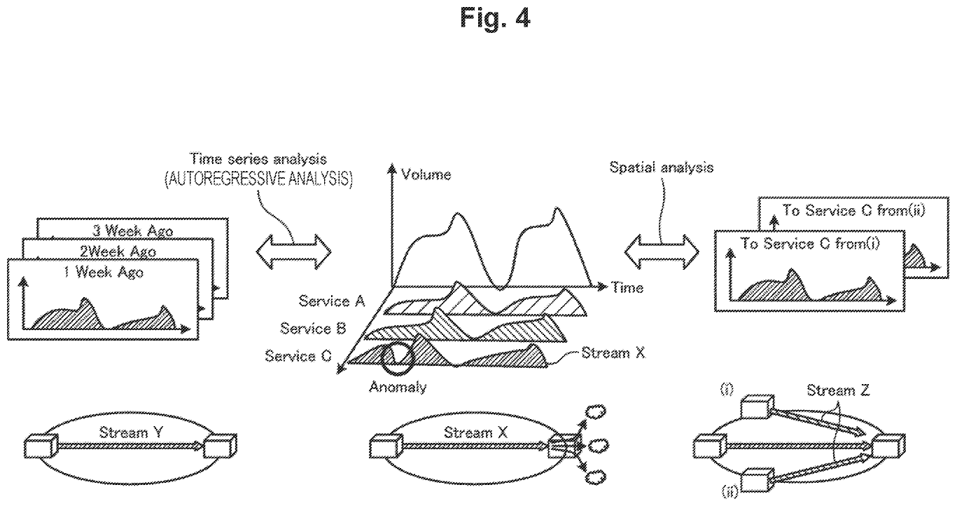

With reference to FIG. 4, details of each unit of the control unit 15 will be described together with a flow of analysis processing by the analysis device 10. FIG. 4 is a diagram for explaining a flow of analysis processing.

The division unit 151 divides communication traffic in the communication network N into a plurality of streams.

Here, it is assumed that the communication traffic has been acquired by the monitoring device 20 and stored in the traffic DB 144.

For example, the division unit 151 divides the communication traffic into flows by a 5-tuple. The divided flow is referred to as a stream.

The 5-tuple is five items of a transmission source IP address, a transmission source port number, a destination IP address, a destination port number, and a protocol type. For example, the division unit 151 divides a packet constituting communication traffic into streams for each transmission source IP address. At this time, each stream includes a packet having a common transmission source IP address.

In a carrier network, a packet may be encapsulated by a tunneling protocol. Therefore, the division unit 151 divides the communication traffic by the methods described in Reference Literature 1 to 3. Accordingly, even when a packet is encapsulated, communication traffic can be divided by the 5-tuple.
Reference Literature 1: JP 2019-097069 A
Reference Literature 2: JP 2021-090161 A
Reference Literature 3: WO 2021/149245 A

For example, Reference Literature 1 describes a method of determining a protocol stack pattern of a packet and converting a format according to the determined protocol stack pattern.

In the example of FIG. 4, the division unit 151 divides the communication traffic into three streams including a stream X (Stream X). Here, the stream X is an example of the first stream.

Here, the stream X is a stream which is an analysis target. However, the analysis device 10 can perform analysis similar to that of the stream X on the stream obtained by the division.

The calculation unit 152 calculates a score 1 based on the result of the autoregressive analysis of the stream X among the plurality of streams and a score 1 based on the comparison result between the stream X and a stream Z similar to the stream X.

Note that the autoregressive analysis can be referred to as comparison with the stream Y that is the past stream of the stream X.

The stream Z is an example of the second stream. Further, the score 1 is an example of the first abnormality degree. Further, a score 2 is an example of the second abnormality degree.

First, a sequence (stream) X^{raw} which is the analysis target is represented by a vector of Formula (1).

$$\begin{matrix}[ Math . 1 ] & \\ {X}^{raw} = ( {x}_{1}^{raw} , {x}_{2}^{raw} , … , {x}_{n}^{raw} ) ∈ {ℝ}^{n} & ( 1 )\end{matrix}$$

The calculation unit 152 normalizes X^{raw} to obtain the stream X of Formula (2). The normalization method is as shown in Formula (3).

$$\begin{matrix}[ Math . 2 ] & \\ X = ( {x}_{1} , {x}_{2} , … , {x}_{n} ) ∈ {ℝ}^{n} & ( 2 )\end{matrix}$$

$$\begin{matrix}[ Math . 3 ] & \\ {x}_{i} = {x}_{i}^{raw} / ‖ X ‖ = {x}_{i}^{raw} / \sqrt{{\sum }_{j = 1}^{n} {( {x}_{j}^{raw} )}^{2}} & ( 3 )\end{matrix}$$

Formula (4) is obtained by normalizing the past stream Y (Y^{T}) of the stream X. The calculation unit 152 calculates an average value (average vector) of the streams Y as shown in Formula (5). The method of calculating the average value is as shown in Formula (6). Y^{T} is a time-series vector. T represents time.

$$\begin{matrix}[ Math . 4 ] & \\ {Y}^{T} = ( {y}_{1}^{T} , {y}_{2}^{T} , … , {y}_{n}^{T} ) ∈ {ℝ}^{n} & ( 4 )\end{matrix}$$

$$T = 1 , 2 , … , {T}_{m}$$

$$\begin{matrix}[ Math . 5 ] & \\ \overline{Y} = ( \overline{{y}_{1}} , \overline{{y}_{2}} , … , \overline{{y}_{n}} ) ∈ {ℝ}^{n} & ( 5 )\end{matrix}$$

$$\begin{matrix}[ Math . 6 ] & \\ {\overline{y}}_{i} = \frac{1}{{T}_{m}} {\sum }_{j = 1}^{{T}_{m}} {y}_{i}^{j} & ( 6 )\end{matrix}$$

Each element of the stream Y may be created for each sliding window. Here, T is the start time of the sliding window.

Formula (7) is obtained by normalizing the stream Z (Z^{S}) similar to the stream X. The calculation unit 152 calculates an average value (average vector) of the streams Z as shown in Formula (8). The method of calculating the average value is as shown in Formula (9). S represents a service related to communication traffic, a base station, and the like.

$$\begin{matrix}[ Math . 7 ] & \\ {Z}^{S} = ( {z}_{1}^{S} , {z}_{2}^{S} , … , {z}_{n}^{S} ) ∈ {ℝ}^{n} & ( 7 )\end{matrix}$$

$$S = 1 , 2 , … , \text{?}$$

$$\begin{matrix}[ Math . 8 ] & \\ \overline{Z} = ( \overline{{z}_{1}} , \overline{{z}_{2}} , … , \overline{{z}_{n}} ) ∈ {ℝ}^{n} & ( 8 )\end{matrix}$$

$$\begin{matrix}[ Math . 9 ] & \\ {\overline{z}}_{i} = \frac{1}{{S}_{i}} \text{?} {z}_{i}^{j} & ( 9 )\end{matrix}$$

$$\text{?} \text{indicates text missing or illegible when filed}$$

Note that x₁^{raw} and the like before normalization are, for example, the communication data size, the number of packets, and the like of the stream X. In addition, x₁, y₁^{T}, z₁^{S}, and the like can be referred to as values obtained by normalizing the communication data size, the number of packets, and the like, which are feature amounts.

The calculation unit 152 removes noise by calculating an average value for the stream Y and the stream Z.

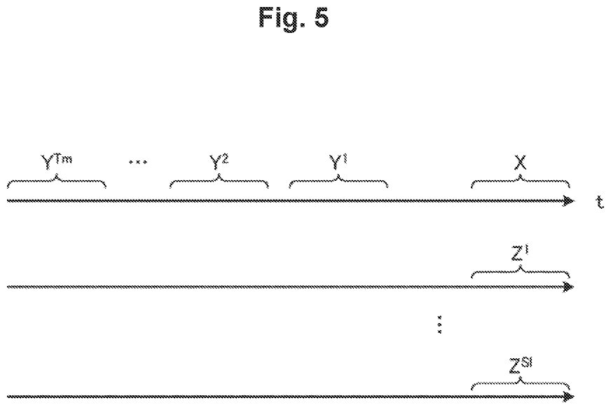

A relationship among the stream X, the stream Y, and the stream Z is expressed as illustrated in FIG. 5. FIG. 5 is a diagram for explaining each stream.

The stream Y is positioned in the past on the time series with respect to the stream X. On the other hand, the stream Z occurs at the same time as the stream X.

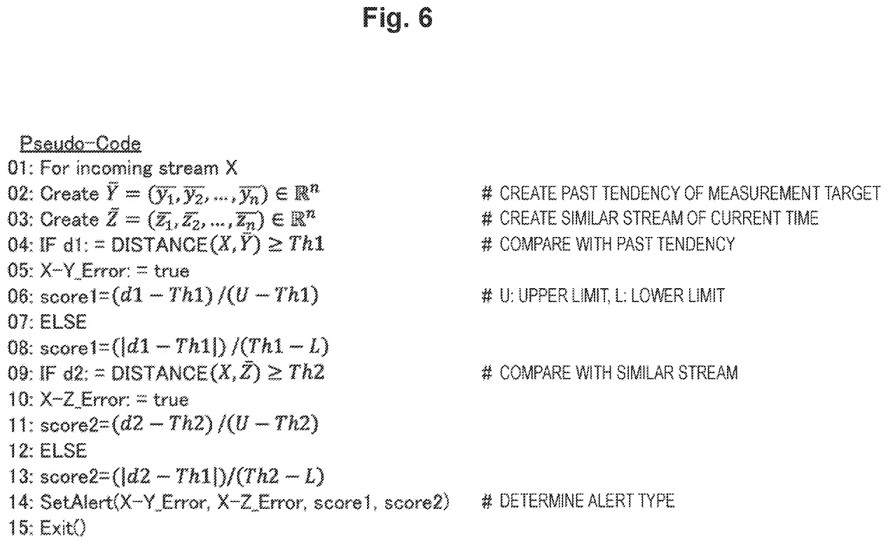

The calculation unit 152 performs calculation according to the code of FIG. 6. FIG. 6 is a diagram illustrating an example of codes of a program for executing analysis.

Note that the calculation unit 152 executes steps from the first line to the thirteenth line in FIG. 6. The step in the fourteenth line is executed by the determination unit 153. Note that the character strings after # are comments.

First, as illustrated in the second line, the calculation unit 152 calculates an average value of the streams Y (past tendency of the measurement target). Furthermore, as illustrated in the third line, the calculation unit 152 calculates an average value of the streams Z (a similar stream of the current time). The current time means a time when the stream X is generated. The respective average values are calculated by the above-described Formulas (4) to (9).

Here, when the distance (d1) between the stream X and the average value of the streams Y is equal to or larger than the threshold (Th1) (the fourth line is true), the calculation unit 152 sets a bit in X−Y_Error (substitutes true). In this case, the calculation unit 152 further calculates the score 1 as in the sixth line.

On the other hand, in a case where the distance (d1) between the stream X and the average value of the streams Y is not equal to or larger than the threshold (Th1) (the fourth line is false), the calculation unit 152 calculates the score 1 as in the eighth line.

In this manner, the calculation unit 152 calculates the score 1 based on the difference between the feature amount of the stream X in the predetermined period and the average value of the feature amounts (streams Y) in the period before the predetermined period of the stream X.

Then, when the distance (d2) between the stream X and the average value of the streams Z is equal to or larger than the threshold (Th2) (the ninth line is true), the calculation unit 152 sets a bit in X−Z_Error (substitutes true). In this case, the calculation unit 152 further calculates the score 2 as in the eleventh line.

On the other hand, in a case where the distance (d2) between the stream X and the average value of the streams Z is not equal to or larger than the threshold (Th2) (the ninth line is false), the calculation unit 152 calculates the score 2 as in the thirteenth line.

In this manner, the calculation unit 152 calculates the score 2 based on the difference between the feature amount of the stream X and the average value of the feature amounts of the plurality of streams Z.

Note that U is a constant representing an upper limit, and is larger than Th1 and Th2. On the other hand, L is a constant representing a lower limit, and is smaller than Th1 and Th2.

DISTANCE in the fourth and ninth lines is a function that outputs the degree of difference between vectors. In the function DISTANCE, the calculation unit 152 can calculate the degree of difference by a Euclidean distance between vectors, a correlation value, cosine similarity, dynamic time warping (DTW), comparison of frequency components (conversion by Fourier transform is necessary), or the like. It can be said that the larger the distances d1 and d2, the larger the degree of difference and the smaller the similarity.

For example, when the stream X is communication traffic for one day in which a certain user uses a certain service, the stream Y may be communication traffic in which the user has used the service for the past one week.

Furthermore, for example, when the stream X is communication traffic that a certain user uses a certain service, the stream Z may be communication traffic that another user uses the same service or communication traffic that the user uses another service.

At that time, the calculation unit 152 calculates the score 2 based on the comparison result between the stream X and the stream Z in which only one of the corresponding user and service is different from the stream X.

How long the stream Y goes back to the past and how many users or services the stream Z includes can be set as parameters in any manner. The number of comparison targets for increasing these parameters increases, and the analysis accuracy of the analysis device 10 is improved, but the calculation load increases.

The determination unit 153 determines whether the cause of the abnormality is the stream X, the stream different from the stream X, or the communication network N based on the score 1 and the score 2.

For example, as illustrated in the fourteenth line of FIG. 6, the determination unit 153 determines the alert type based on the X−Y_Error, the X−Z_Error, the score 1, and the score 2.

A method of determining the alert type by the determination unit 153 will be described separately for a case where the stream X is a stream from the service side and a case where the stream X is a stream from the access side.

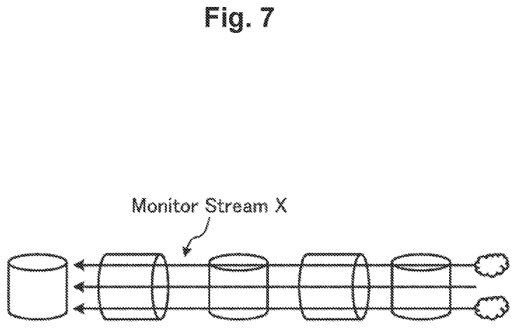

FIG. 7 is a diagram for explaining a stream from the service side. As illustrated in FIG. 7, the stream from the service side is, for example, communication traffic transmitted from the OTT.

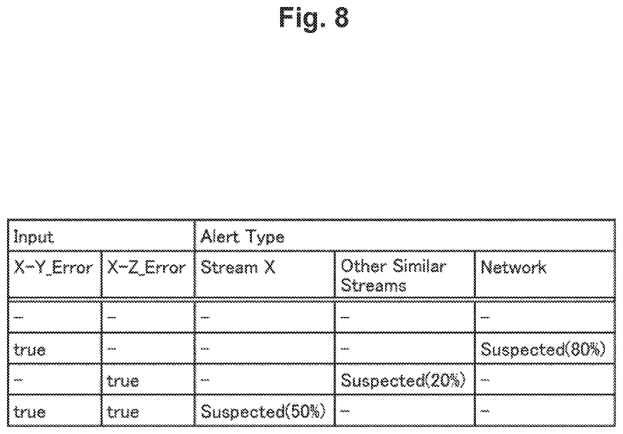

FIG. 8 is a diagram for explaining a method of determining a type of an alert related to the stream from the service side.

As illustrated in FIG. 8, in a case where the X−Y_Error is true and the X−Z_Error is not true, the determination unit 153 identifies that the communication network (N) is suspicious. Note that the suspicion means that, for example, there is a high possibility that a failure has occurred.

This is because the stream X is different from the past tendency, but has the same tendency as the similar streams at the same time, and thus it is suspected that the communication network N itself at the current time is abnormal.

Furthermore, in a case where the X−Y_Error is not true and the X−Z_Error is true, the determination unit 153 identifies that a stream other than the stream X is suspicious. This means that there is a high possibility that a failure has occurred in a user other than the user corresponding to the stream X or a service other than the service corresponding to the stream X.

This is because the stream X is the same as the past tendency, but has the tendency different from the similar streams at the same time, and thus it is suspected that similar streams are more abnormal.

Furthermore, in a case where the X−Y_Error is true and the X−Z_Error is true, the determination unit 153 identifies that the stream X is suspicious. This means that there is a high possibility that a failure has occurred in the user corresponding to the stream X or the service corresponding to the stream X.

This is because the stream X is different from the past tendency, and further has the tendency different from the similar streams at the same time, and thus it is suspected that stream X is abnormal.

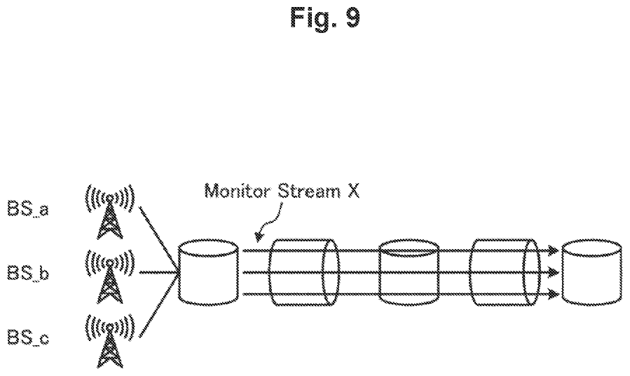

FIG. 9 is a diagram for explaining a stream from the access side. As illustrated in FIG. 9, the stream from the access side is communication traffic transmitted from the user accommodated in the base station.

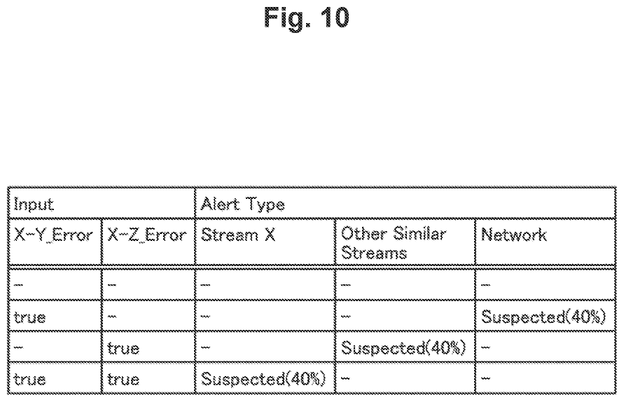

FIG. 10 is a diagram illustrating a method of determining a type of an alert related to the stream from the access side.

As illustrated in FIG. 10, in a case where the X−Y_Error is true and the X−Z_Error is not true, the determination unit 153 identifies that the communication network (N) is suspicious.

Furthermore, in a case where the X−Y_Error is not true and the X−Z_Error is true, the determination unit 153 identifies that a stream other than the stream X is suspicious. This means that there is a high possibility that a failure has occurred in a user different from the user corresponding to the stream X or in a base station different from the base station accommodating the user corresponding to the stream X.

Furthermore, in a case where the X−Y_Error is true and the X−Z_Error is true, the determination unit 153 identifies that the stream X is suspicious. This means that there is a high possibility that a failure has occurred in the user corresponding to the stream X or the base station accommodating the user.

In addition, the determination unit 153 outputs the identified suspicious target together with the accuracy. The determination unit 153 can calculate the accuracy from the score 1 and the score 2.

For example, in a case where only the X−Y_Error is true, the determination unit 153 sets the score 1 as accuracy. In addition, for example, in a case where only the X−Z_Error is true, the determination unit 153 sets the score 2 as accuracy. Furthermore, for example, in a case where both X−Y_Error and X−Z_Error are true, the determination unit 153 sets the average of the score 1 and the score 2 as the accuracy.

For example, Suspected (80%) means an object of suspicion with an accuracy of 80% (0.8).

### (Threshold Learning)

The analysis device 10 can adjust the threshold by learning. For example, the calculation unit 152 records the degree of deviation (upper deviation, lower deviation) between d1 of the fourth line and d2 of the ninth line in FIG. 6 and each threshold.

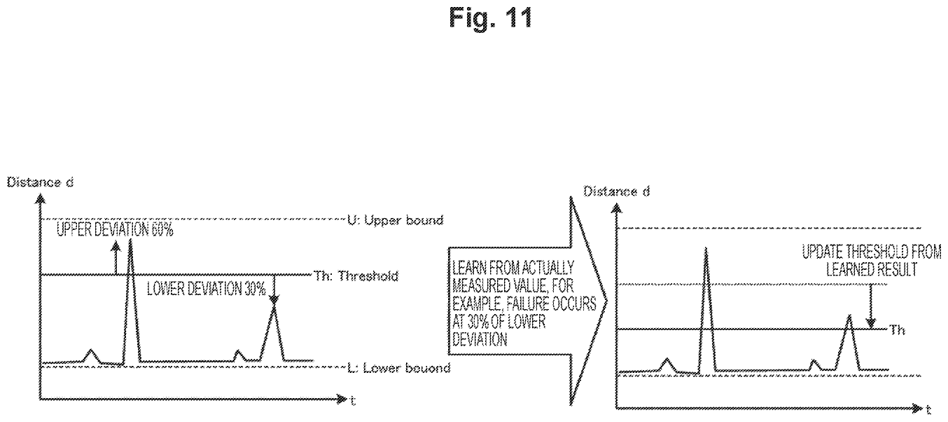

Then, for example, in a case where it is found later that a failure has occurred at the time of 30% of the lower deviation in FIG. 11, the analysis device 10 updates the threshold (for example, Th1) such that the sample can be determined to be abnormal (for example, the fourth line is true). FIG. 11 is a diagram for explaining a method for learning a threshold.

### (Focused Monitoring of Specific User)

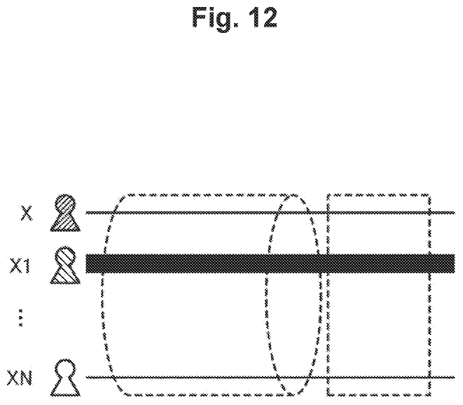

FIG. 12 is a diagram for explaining focused monitoring of a specific user. When there is no abnormality as a result of analyzing the target user as the stream X, the analysis device 10 determines the X−Y_Error for the streams X1, X2, . . . , and XN of the user who uses the same network facility as the target user.

The user who uses the same network facility as the target user is, for example, a user who exists on the same link and SR path as the target user.

At that time, in a case where a change is seen in the user in which the X−Y_Error occurs such that the communication traffic greatly increases, the analysis device 10 considers that the user may affect the target user, and outputs an alert.

### Processing of First Embodiment

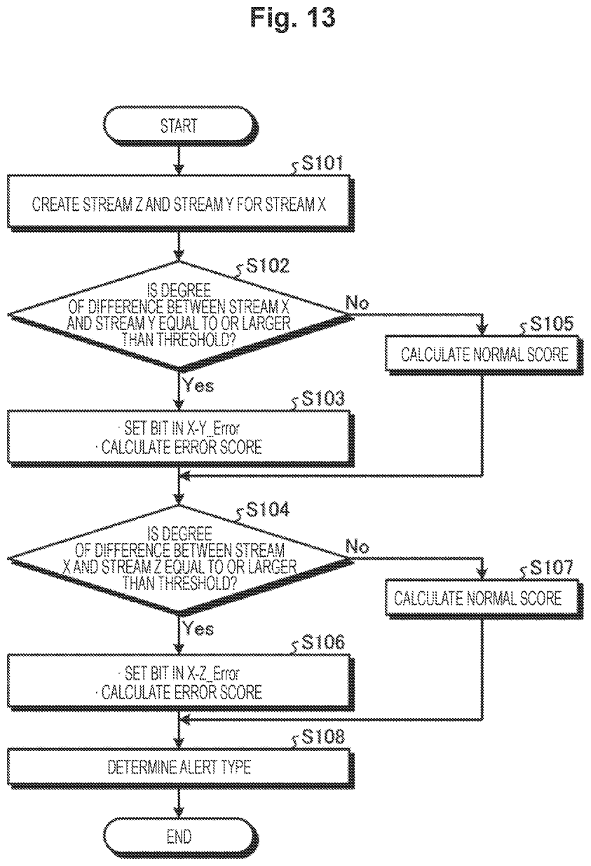

FIG. 13 is a flowchart illustrating a flow of processing of the analysis device according to the first embodiment. As illustrated in FIG. 13, first, the analysis device 10 creates the stream Z and the stream Y for the stream X (step S101).

When the degree of difference between the stream X and the stream Y (d1 on the fourth line in FIG. 6) is equal to or greater than the threshold (step S102, Yes), the analysis device 10 sets a bit in the X−Y_Error and calculates an error score (score 1 on the sixth line in FIG. 6) (step S103).

On the other hand, when the degree of difference between the stream X and the stream Y is not equal to or greater than the threshold (step S102, No), the analysis device 10 calculates a normal score (score 1 in the eighth line in FIG. 6) (step S105).

When the degree of difference between the stream X and the stream Z (d2 on the ninth line in FIG. 6) is equal to or greater than the threshold (step S104, Yes), the analysis device 10 sets a bit in the X−Z_Error and calculates an error score (score 2 on the ninth line in FIG. 6) (step S106).

On the other hand, when the degree of difference between the stream X and the stream Z is not equal to or greater than the threshold (step S104, No), the analysis device 10 calculates a normal score (score 2 in the thirteenth line in FIG. 6) (step S107).

Then, the analysis device 10 determines an alert type based on the X−Y_Error, the X−Z_Error, the score 1, and the score 2 (step S108).

### Effects of First Embodiment

As described above, the division unit 151 divides communication traffic in the communication network into a plurality of streams. The calculation unit 152 calculates the first abnormality degree based on the result of autoregressive analysis of the first stream among the plurality of streams, and the second abnormality degree based on the comparison result between the first stream and the second stream similar to the first stream.

In this manner, the analysis device 10 can perform analysis after dividing the communication traffic. As a result, according to the embodiment, the traffic analysis of the carrier network can be accurately performed.

Furthermore, by accurately analyzing the communication traffic of the carrier network, it is possible to promptly detect an abnormality at the service end end including an abnormality on the access side or the OTT side and realize stable use of the social infrastructure.

The calculation unit 152 calculates the first abnormality degree based on a difference between a feature amount of the first stream in a predetermined period and an average value of feature amounts of the first stream in a period before the predetermined period.

As a result, it is possible to perform comparative analysis with the past tendency after reducing the error.

The calculation unit 152 calculates the second abnormality degree based on the difference between the feature amount of the first stream and the average value of the feature amounts of the plurality of second streams.

As a result, it is possible to perform comparative analysis with streams occurring planarly at the same time after reducing the error.

The calculation unit 152 calculates the second abnormality degree based on the comparison result between the first stream and the second stream in which only one of the corresponding user and service is different from the first stream.

As a result, it is possible to perform comparative analysis with similar streams in which users or services are common.

The determination unit 153 determines whether the cause of the abnormality is the first stream, the stream different from the first stream, or the communication network based on the first abnormality degree and the second abnormality degree.

As a result, it is possible to provide the user with specific information regarding a response to the failure.

### [System Configuration and Others]

Moreover, each component of each illustrated device is functionally conceptual, and does not necessarily need to be physically configured as illustrated. That is, a specific form of distribution and integration of each device is not limited to the illustrated form, and all or some thereof can be functionally or physically distributed or integrated in any unit according to various loads, use status, and the like. Furthermore, all or any part of each processing function performed in each device can be realized by a central processing unit (CPU) and a program analyzed and executed by the CPU, or may be realized as hardware by wired logic. Note that the program may be executed not only by a CPU but also by another processor such as a GPU.

Moreover, among the respective processing described in the present embodiment, all or some of the processing described as being automatically performed can be manually performed, or all or some of the processing described as being manually performed can be automatically performed by a known method. In addition, a processing procedure, a control procedure, specific names, and information including various items of data and parameters illustrated in the above-described document and the drawings can be freely changed unless otherwise specified.

### [Program]

In an embodiment, the analysis device 10 can be implemented by installing an analysis program that executes the analysis processing as packaged software or online software in a desired computer. For example, an information processing device is caused to execute the above-described analysis program, and thereby the information processing device can be caused to function as the analysis device 10. The information processing device mentioned here includes a desktop or a laptop personal computer. In addition, the information processing device includes a mobile communication terminal such as a smartphone, a mobile phone, or a personal handyphone system (PHS) and a slate terminal such as a personal digital assistant (PDA).

In addition, in a case where a terminal device used by a user is implemented as a client, the analysis device 10 can be implemented as an analysis server device that provides a service regarding the above analysis processing for the client. For example, the analysis server device is implemented as a server device that provides an analysis service having communication traffic as an input and an analysis result as an output. In this case, the analysis server device may be implemented as a web server or may be implemented as a cloud that provides a service related to the above analysis processing by outsourcing.

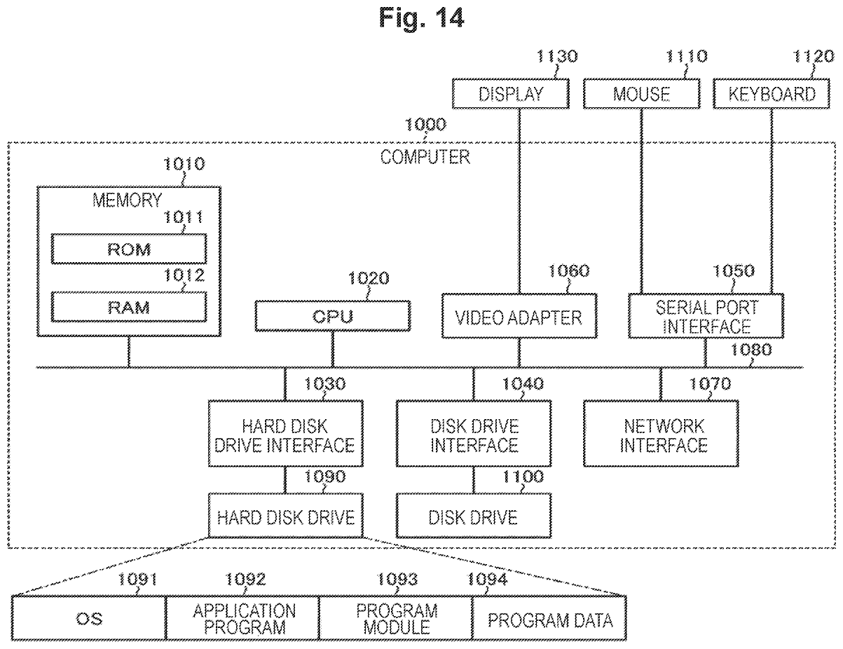

FIG. 14 illustrates an example of a computer that executes an analysis program. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each processing operation of the analysis device 10 is implemented as the program module 1093 in which a code executable by a computer is described. The program module 1093 is stored in, for example, the hard disk drive 1090. For example, the program module 1093 for executing processing similar to the functional configuration in the analysis device 10 is stored in the hard disk drive 1090. Further, the hard disk drive 1090 may be replaced with a solid state drive (SSD).

Further, setting data used in the processing of the above embodiment is stored in, for example, the memory 1010 or the hard disk drive 1090 as the program data 1094. Then, the CPU 1020 reads the program module 1093 and the program data 1094 stored in the memory 1010 or the hard disk drive 1090 to the RAM 1012 as necessary and executes the processing of the above embodiment.

Further, the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

N Communication network
10 Analysis device
11 Communication unit
12 Input unit
13 Output unit
14 Storage unit
15 Control unit
20 Monitoring device
30 Node
141 Analysis result DB
142 Route DB
143 Topology DB
144 Traffic DB
151 Division unit
152 Calculation unit
153 Determination unit

1. An analysis device comprising:
a division unit, comprising one or more processors, configured to divide communication traffic in a communication network into a plurality of streams; and
a calculation unit, comprising one or more processors, configured to calculate a first abnormality degree based on a result of autoregressive analysis of a first stream among the plurality of streams, and a second abnormality degree based on a comparison result between the first stream and a second stream similar to the first stream.

2. The analysis device according to claim 1, wherein the calculation unit is configured to calculate the first abnormality degree based on a difference between a feature amount of the first stream in a predetermined period and an average value of feature amounts of the first stream in a period before the predetermined period.

3. The analysis device according to claim 1, wherein the calculation unit is configured to calculate the second abnormality degree based on a difference between the feature amount of the first stream and an average value of feature amounts of the plurality of second streams.

4. The analysis device according to claim 1, wherein the calculation unit is configured to calculate the second abnormality degree based on a comparison result between the first stream and the second stream in which only one of the corresponding user and service is a stream different from the first stream.

5. The analysis device according to claim 1, further comprising: a determination unit, comprising one or more processors, configured to determine whether a cause of the abnormality is the first stream, a stream different from the first stream, or the communication network, based on the first abnormality degree and the second abnormality degree.

6. An analysis method executed by an analysis device, the method comprising:
dividing communication traffic in a communication network into a plurality of streams; and
calculating a first abnormality degree based on a result of autoregressive analysis of a first stream among the plurality of streams, and a second abnormality degree based on a comparison result between the first stream and a second stream similar to the first stream.

7. A non-transitory computer readable medium storing a program, wherein executing of the program causes a computer to function as the analysis device according to claim 1.
